(19) United States
(12) Patent Application Publication
(10) Pub. No.: US 2005/0278772 A1
(43) Pub. Date: Dec. 15, 2005

(54) Program effect creating device, a receiving device, a program effect creating program, and a computer-readable recording medium

(76) Inventor: Tetsuya Hiramoto, Toyota-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/139,589

(22) Filed: May 31, 2005

(30) Foreign Application Priority Data
Jun. 1, 2004 (JP) 2004-163554

(51) Int. Cl. H04N 7/16

(52) U.S. Cl. 725/138; 725/135

(57) ABSTRACT

The present invention relates to a program effect creating device for performing effect creation for a broadcast program by receiving a command and executing the received command in synchronization with a predetermined scene in the broadcast program. The program effect creating device comprises: a memory unit operable to store a predefined identifier; a judgment unit operable to judge whether an identifier appended to the received command agrees with the predefined identifier stored by the memory unit; and an execution unit operable to, when a judgment result of the judgment unit is affirmative, decode and execute the received command to thereby perform the effect creation.

### BACKGROUND OF THE INVENTION

[1] Field of the Invention

The present invention relates to a device for receiving pieces of control data related to a broadcast program in digital broadcasting and creating effects for the broadcast program, and in particular to a technology for preventing operations unintended by the user.

[2] Description of the Related Art

In recent years, digitization of broadcasting is accelerating at speed. Digitization allows new broadcasting services such as high-quality picture broadcasting, multichannel broadcasting, data broadcasting, and broadcasting for mobile devices. One such service is a service for creating effects to convey a sense of actual presence for a broadcast program by using a data broadcast function. Specifically speaking, a broadcasting station transmits broadcast programs and pieces of predetermined control data associated with the broadcast programs to receiving devices such as digital televisions. When receiving these, a receiving device transmits the pieces of control data to one or more devices, each of which performs effect creation based on the pieces of control data (hereinafter, referred to as “program effect creating devices”). The program effect creating devices create effects based on the pieces of control data in synchronization with scenes of broadcast programs. Here, the program effect creating devices are, for example, a transformation belt, a lighting apparatus, and audio equipment. When the program effect creating device is a transformation belt, for instance, the transformation belt is used for a broadcast program having a character that can transform into a superhero. The transformation belt flashes and/or generates a sound in synchronization with transformation scenes of the character in the broadcast program, which is expected to lead to effects for enhancing a realistic sense of presence.

However, it is conceivable that the program effect creating devices could operate against the user's intention. For example, in the case when a program effect creating device A for a broadcast program A and a program effect creating device B for a broadcast program B are designed to operate by the same instruction codes of control data, these program effect creating devices may unreasonably operate during an irrelevant broadcast program. For example, the program effect creating device B carries on its function during the broadcast program A, operating irrespectively of the broadcast program A. This is attributed to the fact that terminal-to-terminal wireless communication, such as a wireless LAN, Bluetooth, and infrared communication, is applied for communication between the receiving device and the program effect creating device, and therefore a bit width for transmittable control data is only 8 bits or so. As a result, it is often the case that the same bit patterns representing instruction codes are shared among multiple program effect creating devices.

In addition, program effect creating devices are likely to operate also when receiving control data transmitted from a receiving device in a different room via the above-mentioned terminal-to-terminal wireless communication. For example, when there is another receiving device in an adjoining room, program effect creating devices may receive control data from multiple receiving devices.

### SUMMARY OF THE INVENTION

The present invention has been made in view of the above problems, and aims at offering a program effect creating device which prevents operations unintended by the user.

In order to solve the above problems, the program effect creating device of the present invention performs effect creation for a broadcast program by receiving a command and executing the received command in synchronization with a predetermined scene in the broadcast program. The program effect creating device comprises: a memory unit operable to store a predefined identifier; a judgment unit operable to judge whether an identifier appended to the received command agrees with the predefined identifier stored by the memory unit; and an execution unit operable to, when a judgment result of the judgment unit is affirmative, decode and execute the received command to thereby perform the effect creation. According to the above structure, the program effect creating device of the present invention performs program effect creation when a predetermined identifier stored by the memory unit and an identifier added to the command agree with each other, and herewith does not perform erroneous operations. Accordingly, the program effect creating device avoids performing program effect creation unintended by the user.

In this case, the predefined identifier may be a program identifier identifying the broadcast program with which the program effect creating device is to synchronize. Here, the appended identifier includes a program identifier identifying a broadcast program currently being broadcast; the judgment unit judges whether the program identifiers agree with each other.

According to the above structure, the program effect creating device of the present invention performs program effect creation when a program ID stored by the memory unit and used for identifying a broadcast program with which the program effect creating device is to synchronize agrees with a program ID added to the command and used for identifying a broadcast program currently being broadcast. As a result, the program effect creating device avoids performing program effect creation in conjunction with irrelevant broadcast programs, and thus program effect creation unintended by the user can be prevented.

In this case, the predefined identifier may be a device identifier indicating the program effect creating device. Here, the appended identifier includes a device identifier specifying a program effect creating device by which the received command is to be executed; the judgment unit judges whether the device identifiers agree with each other.

According to the above structure, the program effect creating device of the present invention performs program effect creation when a device ID stored by the memory unit and identifying the program effect creating device agrees with a device ID added to the command and identifying a program effect creating device by which the command is to be executed. As a result, operations of irrelevant devices are prevented, which in turn prevents program effect creation unintended by the user.

In this case, the program effect creating device may further comprise: a DIP switch value memory unit operable to store a setting value of a DIP switch provided in the program effect creating device. Here, the appended identifier includes a setting value of a DIP switch provided in a receiving device by which the command was transmitted to the program effect creating device; the judgment unit further judges whether the setting values agree with each other.

According to the above structure, the program effect creating device of the present invention further identifies receiving devices according to DIP SW values. Herewith, the program effect creating device avoids performing program effect creation when receiving data transmitted from a receiving device in an adjoining room, for example.

In this case, the program effect creating device may further comprise: a serial number memory unit operable to store a serial number specifying a receiving device corresponding to the program effect creating device. Here, the appended identifier includes a serial number specifying a receiving device by which the command was transmitted to the program effect creating device; the judgment unit further judges whether the serial numbers agree with each other.

According to the above structure, the program effect creating device of the present invention further identifies receiving devices according to serial numbers assigned to these receiving devices, and performs program effect creation only when serial numbers agree with each other. Accordingly, when receiving data from a receiving device having a mismatched serial number, the program effect creating device does not operate, which in turn prevents erroneous operations.

The receiving device of the present invention receives a program stream to which one or more commands are appended. The receiving device comprises: a receiving unit operable to receive a condition list specifying execution conditions of a plurality of commands prior to the reception of the program stream; a selection unit operable to display the received condition list and select at least one of the execution conditions from the displayed condition list according to a user operation; an extraction unit operable to extract the appended commands upon the reception of the program stream; a judgment unit operable to judge whether a predefined identifier included in each of the extracted commands agrees with one of the selected execution conditions; and a transmission unit operable to transmit individual extracted commands each including the predefined identifier determined by the judgment unit as to agree with one of the selected execution conditions.

According to the above structure, the receiving device of the present invention transmits only commands conforming to preselected conditions. Accordingly, program effect creation unintended by the user is not performed, which allows the user to comfortably enjoy a broadcast program.

### BRIEF DESCRIPTION OF THE DRAWINGS

These and other objects, advantages and features of the invention will become apparent from the following description thereof taken in conjunction with the accompanying drawings which illustrate specific embodiments of the invention. In the drawings:

FIG. 1 is a system drawing;

FIG. 2 is a functional block diagram of a display device 200;

FIG. 3 is a functional block diagram of a program effect creating device A 300;

FIG. 4 shows program command data;

FIG. 5 shows program effect creating data;

FIG. 6 shows a storage site for the program command data;

FIG. 7 shows timings of pieces of program command data to be stored in a receive buffer;

FIG. 8 is a flowchart showing operations of the program effect creating device;

FIG. 9 is another flowchart showing operations of the program effect creating device A 300;

FIG. 10 is another flowchart showing operations of the program effect creating device B 301;

FIG. 11 is a system drawing;

FIG. 12 is a functional block diagram of a display device 201a according to a second embodiment;

FIG. 13 is a functional block diagram of a program effect creating device 302a according to the second embodiment;

FIG. 14 shows a piece of program effect creating data according to the second embodiment;

FIG. 15 is a flowchart showing operations of the program effect creating device according to the second embodiment;

FIG. 16 is a functional block diagram of a display device 201b according to a third embodiment;

FIG. 17 is a functional block diagram of a program effect creating device 302b according to the third embodiment;

FIG. 18 shows a piece of program effect creating data according to the third embodiment;

FIG. 19 is a flowchart showing operations of the program effect creating device according to the third embodiment;

FIG. 20 is a functional block diagram of a display device 202 according to a fourth embodiment;

FIG. 21 shows a command list;

FIG. 22 shows a piece of program effect creating data;

FIG. 23 shows a command selection screen 2300;

FIG. 24 shows timings of pieces of program command data to be stored in a receive buffer;

FIG. 25 is a flowchart showing operations of a display device 202;

FIG. 26 is a functional block diagram of a program effect creating device having a function to inform a user; and

FIG. 27 is a flowchart showing operations of a program effect creating device having operational steps for informing a user.

### DESCRIPTION OF THE PREFERRED EMBODIMENTS

Preferred embodiments according to the present invention are described below.

### 1. First Embodiment

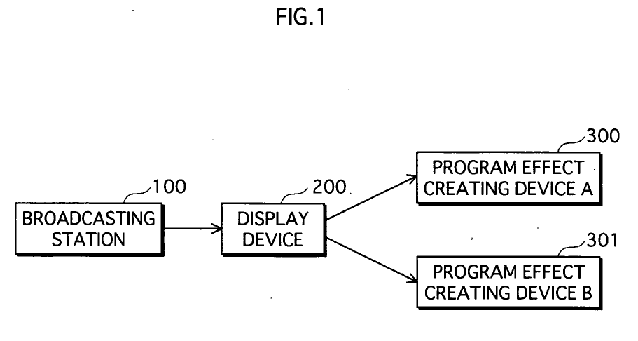

The following gives an account of a preferred embodiment of a program effect creating device according to the present invention. First, a usage application is described in relation to the implementation of the program effect creating devices of the present invention. The program effect creating devices according to the first embodiment are used by a user in a system as shown in FIG. 1. The system in FIG. 1 comprises a broadcasting station 100, a display device 200, a program effect creating device A 300, and a program effect creating device B 301.

The broadcasting station 100 multiplexes a standard broadcast program and pieces of program command data associated with the broadcast program, and broadcasts the multiplexed result as broadcast data. Here, the pieces of program command data associated with the broadcast program are, to be more precise, information necessary to control the program effect creating device A 300 or the program effect creating device B 301.

The display device 200 is a reception device for receiving the broadcast data sent by the broadcasting station 100, and is capable of displaying a standard broadcast program on, for example, a display provided on the display device 200. In addition, the display device 200 has control functions for the program effect creating device A 300 and the program effect creating device B 301. That is, the display device 200 is capable of receiving a piece of program command data transmitted from the broadcasting station 100, and controlling the program effect creating device A 300 or the program effect creating device B 301 based on the piece of program command data.

Each of the program effect creating device A 300 and program effect creating device B 301 receives a piece of program effect creating data, which is a piece of program command data with time information for synchronization excluded therefrom, and executes the piece of program effect creating data according to processing contents of computer programs stored in the program effect creating devices.

Thus completes the description of the usage application of the program effect creating devices.

Next is described the structure of the display device 200, which is followed by a description regarding the structure of the program effect creating devices according to the present invention, with reference to accompanying drawings.

1.1 Structure of Display Device

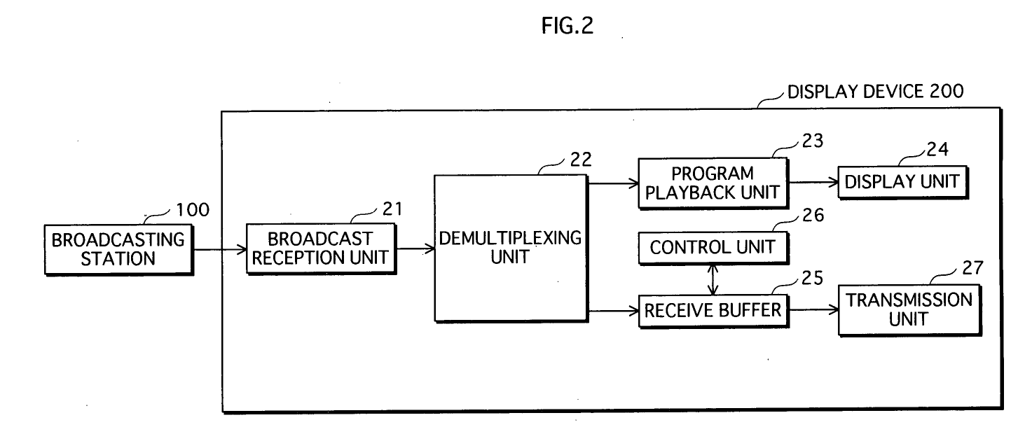

FIG. 2 is a functional block diagram of the display device 200. As shown in the figure, the display device 200 includes: a broadcast reception unit 21; a demultiplexing unit 22; a program playback unit 23; a display unit 24; a receive buffer 25; a control unit 26; and a transmission unit 27.

The display device 200 is, specifically speaking, a computer system structured from such as a microprocessor, ROM, RAM, and a hard disk unit. In the ROM or the hard disk unit, computer programs are stored. The display device 200 performs its function by causing the microprocessor to operate according to the computer programs.

The broadcast reception unit 21 receives a piece of broadcast data sent from the broadcasting station 100, and sends the piece of broadcast data out to the demultiplexing unit 22.

The demultiplexing unit 22 demultiplexes the piece of broadcast data to a broadcast program and pieces of program command data included therein, and sends the broadcast program out to the program playback unit 23 while sending the pieces of program command data out to the receive buffer 25.

The program playback unit 23 plays back the received broadcast program according to a format of the broadcast program thereof by using control parameters, such as time management information, included in the broadcast program.

The display unit 24 displays the broadcast program played back by the program playback unit 23.

The receive buffer 25 stores the pieces of program command data sent out from the demultiplexing unit 22 therein.

The control unit 26 reads a Start_PTS (Presentation Time Stamp) 41 from each piece of program command data stored in the receive buffer 25. When the time reaches a predetermined time stored in the Start_PTS 41, the control unit 26 instructs the receive buffer 25 to send out a piece of program effect creating data 42, which is the piece of program command data with the Start_PTS 41 excluded therefrom, to the transmission unit 27.

The transmission unit 27 transmits the piece of program effect creating data 42 to the program effect creating device A 300 and the program effect creating device B 301.

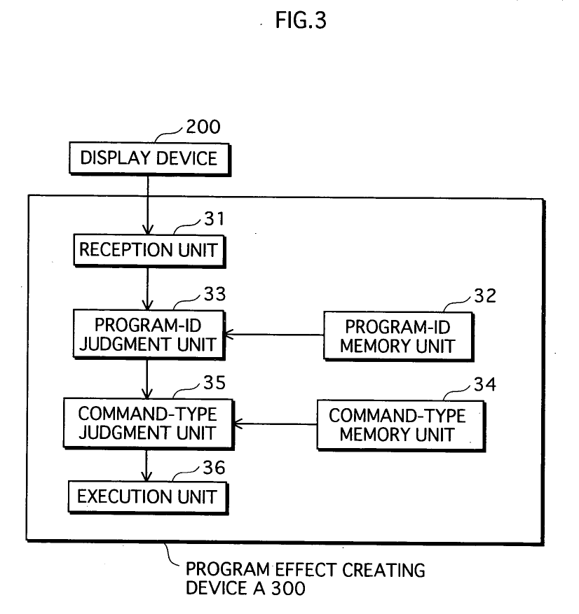

1.2 Structure of Program Effect Creating Devices FIG. 3 shows an internal structure of the program effect creating device A 300 according to the present invention. As shown in the figure, the program effect creating device A 300 of the present invention comprises: a reception unit 31; a program-ID memory unit 32; a program-ID judgment unit 33; a command-type memory unit 34; a command-type judgment unit 35; and an execution unit 36.

The program effect creating device A 300 is, specifically speaking, a computer system structured from a microprocessor, ROM, RAM, and a hard disk unit. In the ROM or the hard disk unit, computer programs are stored. The program effect creating device A 300 performs its function by causing the microprocessor to operate according to the computer programs.

The reception unit 31 receives a piece of program effect creating data 42 transmitted from the display device 200.

The program-ID memory unit 32 stores a program ID 32a which is an identifier for identifying a broadcast program therein.

The program-ID judgment unit 33 judges whether the program ID 32a stored by the program-ID memory unit 32 and a program ID 43 included in the received piece of program effect creating data 42 agree with each other.

The command-type memory unit 34 stores a command type 34a executable by the program effect creating device A 300 therein.

The command-type judgment unit 35 judges whether the command type 34a stored by the command-type memory unit 34 and a command type 44 included in the received piece of program effect creating data 42 agree with each other.

The execution unit 36 executes the received piece of program effect creating data 42 when the judgment results made by the program-ID judgment unit 33 and the command-type judgment unit 35 are both affirmative.

Note that the program effect creating device B 301 has the same structure as the program effect creating device A 300, and therefore a description regarding the structure is here omitted.

1.3 Data

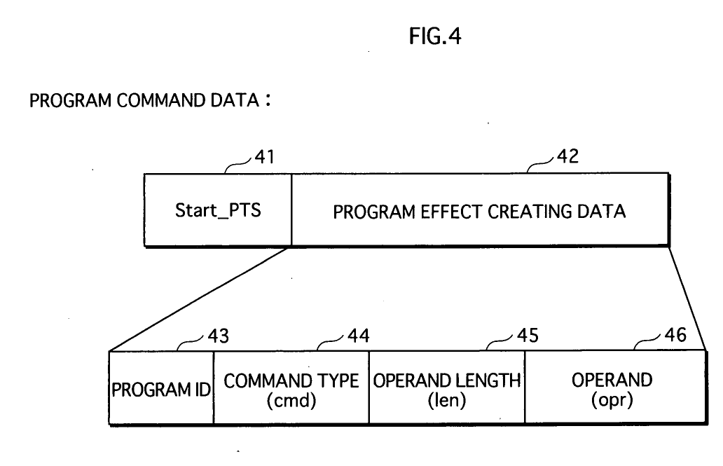

A piece of program command data is described next. As shown in FIG. 4, a piece of program command data is composed of the Start_PTS 41 and a piece of program effect creating data 42.

The Start_PTS 41 indicates the time at which the display device 200 transmits the piece of program effect creating data 42 to the program effect creating device A 300 and program effect creating device B 301. A predetermined broadcast program and a predetermined piece of program command data can be temporally associated with each other by matching a time value of the Start_PTS 41 with the broadcast time of the broadcast program.

The piece of program effect creating data 42 comprises: the program ID 43; the command type (cmd) 44; an operand length (len) 45; and an operand (opr) 46.

The program ID 43 indicates information on a type of program on which the program effect creating device A 300 or the program effect creating device B 301 is able to perform control shown by the cmd 44. The program ID 43 is normally a code corresponding to a singular program name.

The cmd 44 shows a command type indicating a control performed in the program effect creating device A 300 or the program effect creating device B 301.

The len 45 indicates the length of the opr 46 in byte.

The opr 46 is a sub-parameter of the cmd 44, and is capable of storing music data and the like.

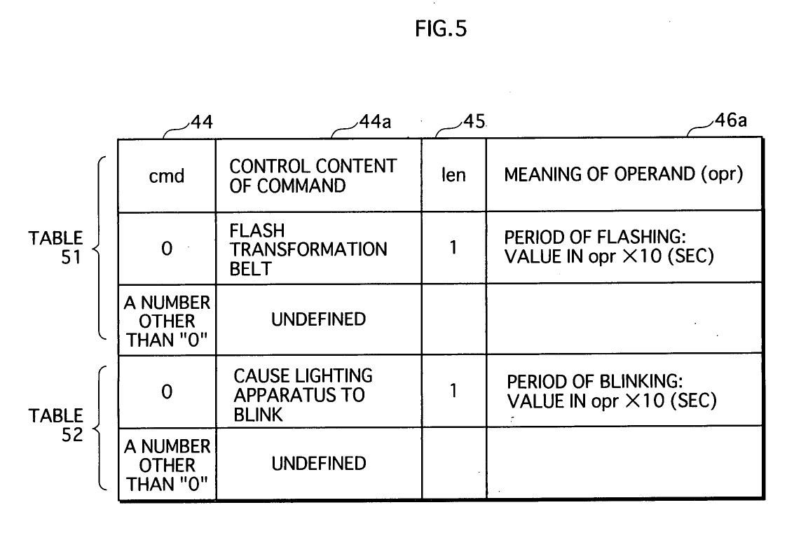

Next, a description of the program effect creating data 42 is provided by assigning specific numbers to values stored in the piece of program effect creating data 42. In the case when the broadcast program is, for example, a program 701 having a character who can transform into a superhero by using a transformation belt, “1” which is information indicating the broadcast program 701 is stored in the program ID 43. In the cmd 44, any command type shown in a table 51 of FIG. 5 is assignable, and each command type has the following meaning.

When the cmd 44 is “0”, the control content of the command is to “flash the transformation belt” while the opr 46 indicating a period of the flashing operation.

When the cmd 44 is “a number other than 0”, the control content of the command is “undefined”. In this case, a provider of the piece of program command data can newly define a given control content of a command, using the number.

In addition, when the broadcast program is, for example, a movie program 702 including a scene of a storm, “2” which is information indicating the movie program 702 is stored in the program ID 43. In the cmd 44, any command type shown in a table 52 of FIG. 5 is assignable, and each command type has the following meaning.

When the cmd 44 is “0”, the control content of the command is to “cause the lighting apparatus to blink” while the opr 46 indicating a period of the blinking operation.

When the cmd 44 is “a number other than 0”, the control content of the command is “undefined”. In this case, a provider of the piece of program command data can newly define a given control content of a command, using the number.

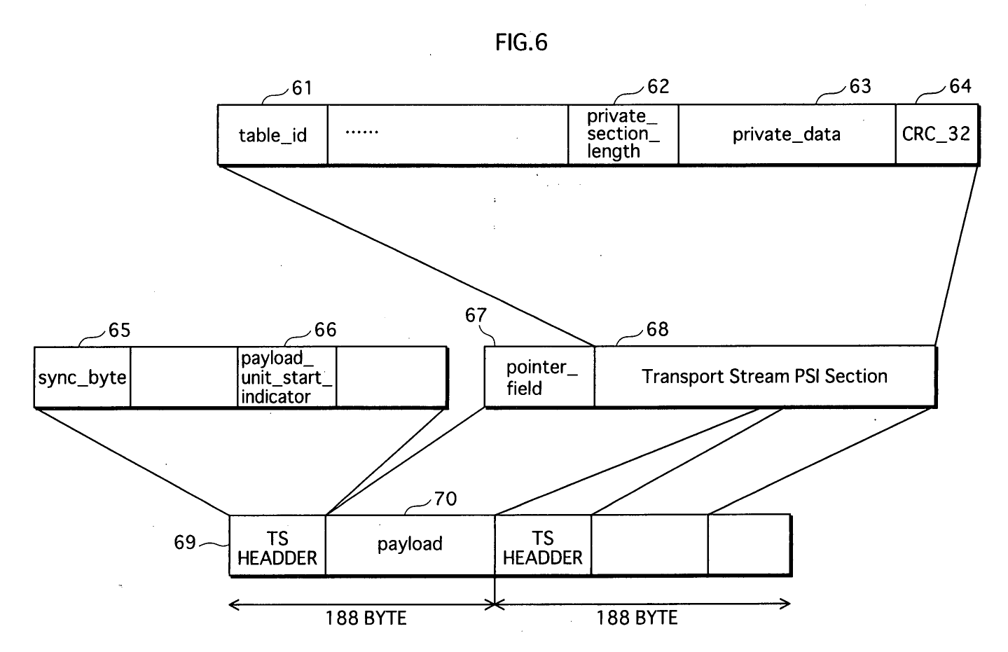

FIG. 6 shows storage sites for a piece of program command data described above when it is superposed on a digital broadcast program. MPEG-2 TS, which is a multiplexing transmission format for video, audio, and data, has been employed in digital broadcasting. Based on the MPEG-2 TS format, a bit string to be transmitted is divided into pieces of equal length to each of which a header is added, and finally transmitted in units called TS packets each having a size of 188 bytes. As shown in FIG. 6, each TS packet comprises a TS header 69 and a payload 70. The TS header 69 includes a sync_byte 65 and a payload_unit_start_indicator 66.

The sync_byte 65 indicates a beginning of the corresponding TS packet.

The payload_unit_start_indicator 66 shows that the first byte of a PES (Packetized Elementary Stream), a section (a data format defined by MPEG-2 TS), or the like are included in the corresponding TS packet. The payload_unit_start_indicator 66 being “1” means that a section starts in the payload 70 of the TS packet. Here, the first byte of the payload 70 in the TS packet is a pointer_field 67 having a value indicating the number of bytes to the a beginning of the first section. For example, when the pointer_field 67 is “0x00”, the aforesaid section starts immediately after the pointer_field 67. The payload_unit_start_indicator 66 being “0” means that a section does not start in the payload 70 of the TS packet. In this case, the pointer_field 67 is not included.

The payload 70 contributes to transmit a PES and sections.

A Transport Stream PSI Section 68 includes: a table_id 61; a private_section_length 62; a private_date 63; and a CRC_32 64.

The table_id 61 shows an identifier indicating a type of each section, and takes a value other than “0xFF”.

The private_section_length 62 indicates length of the section available for users for their own use.

The private_data 63 indicates the piece of program command data.

The CRC_32 64 is an error detecting code.

1.4 Operations of Display Device

This section provides a detailed explanation about processing performed when the display device 200 receives a piece of broadcast data.

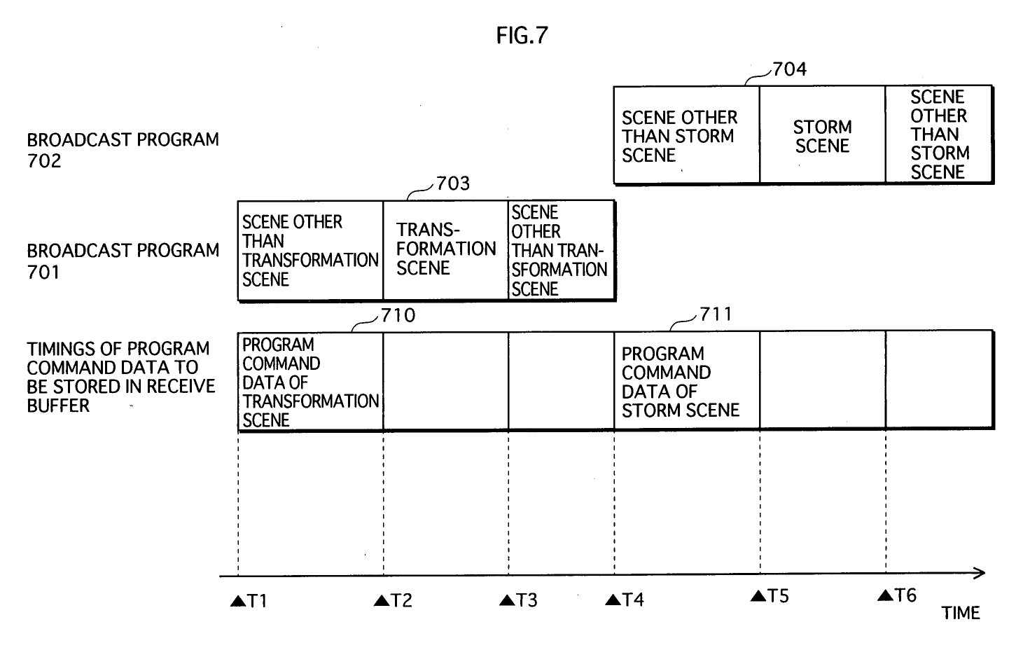

Here, a case described below is considered with the aid of FIG. 7. That is, assume that the broadcast program 701, which is indicated by the program ID of “1”, shown in the above example is to be played back and displayed on the display unit 24. As being played back in the program playback unit 23, a scene with a transformation of the superhero in the broadcast program 701 is displayed on the display unit 24 at a time T2 shown in FIG. 7. In advance of the time T2, the display device 200 completes storing, in the receive buffer 25, a piece of program command data corresponding to the transformation scene, transmitted from the broadcasting station 100.

The control unit 26 reads the Start_PTS 41 of the piece of program command data stored in the receive buffer 25. Here, the time T2 is stored in the Start_PTS 41, and accordingly the control unit 26 instructs the receive buffer 25 to send out the piece of program effect creating data 42 to the transmission unit 27 when the time reaches the time T2. The transmission unit 27 transmits the piece of program effect creating data 42 to the outside of the display device 200. At this point, a piece of program effect creating data 42 comprising the program ID 43 of “1”, the cmd 44 of “0”, the len 45 of “1”, and the opr 46 of “1” is transmitted from the display device 200. Note that, specifically speaking, terminal-to-terminal wireless communication, such as Bluetooth and infrared communication, is used for transmission performed by the transmission unit 27, and actual transmit data is transmitted after being mapped into a packet format according to such a communication protocol.

Next, assume that the broadcast program 702, which is indicated by the program ID of “2”, shown in the above example is to be played back and displayed on the displayed unit 24. As being played back in the program playback unit 23, a storm scene in the broadcast program 702 is displayed on the display unit 24 at a time T5 shown in FIG. 7. In advance of the time T5, the display device 200 completes storing, in the receive buffer 25, a piece of program command data corresponding to the storm scene, transmitted from the broadcasting station 100.

The control unit 26 reads the Start_PTS 41 of the piece of program command data stored in the receive buffer 25. Here, the time T5 is stored in the Start_PTS 41, and accordingly the control unit 26 instructs the receive buffer 25 to send out the piece of program effect creating data 42 to the transmission unit 27 when the time reaches the time T5. The transmission unit 27 transmits the piece of program effect creating data 42 to the outside of the display device 200. At this point, a piece of program effect creating data 42 comprising the program ID 43 of “2”, the cmd 44 of “0”, the len 45 of “1”, and the opr 46 of “1” is transmitted from the display device 200.

1.5 Operations of Program Effect Creating Devices

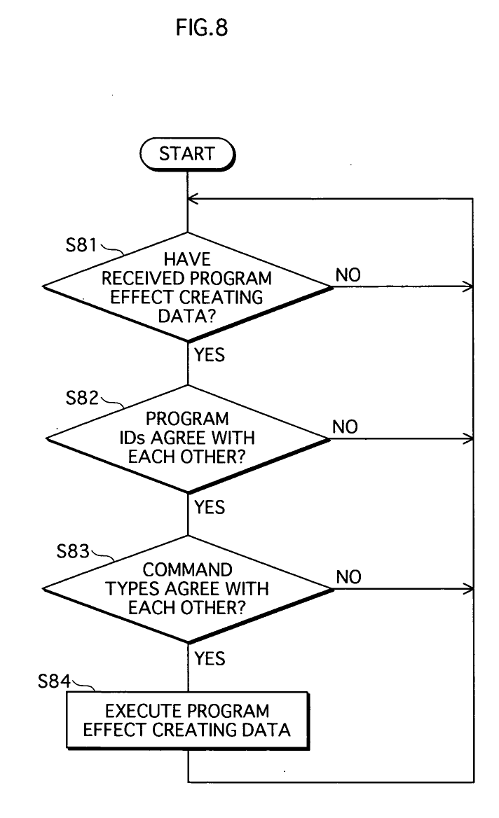

This section provides a detailed explanation about processing performed when the program effect creating device A 300 and program effect creating device B 301 respectively receive a piece of program effect creating data 42, with the aid of a flowchart shown in FIG. 8.

First, the program effect creating device A 300 and program effect creating device B 301 individually judge whether to have received a piece of program effect creating data 42 (Step S81) If NO, these program effect creating devices are in wait mode until receiving one. If YES, each of the program effect creating devices judges whether the program ID 32a stored by its program-ID memory unit 32 and the program ID 43 included in the received piece of program effect creating data 42 agree with each other (Step S82). If NO, the program effect creating device returns to wait mode and stays in the mode until receiving a new piece of program effect creating data 42. If YES, the program effect creating device judges whether the command type 34a stored by the command-type memory unit 34 and the command type 44 included in the received piece of program effect creating data 42 agree with each other (Step S83). If NO, the program effect creating device returns to wait mode and stays in the mode until receiving a new piece of program effect creating data 42. If YES, the program effect creating device executes the piece of program effect creating data 42 (Step S84).

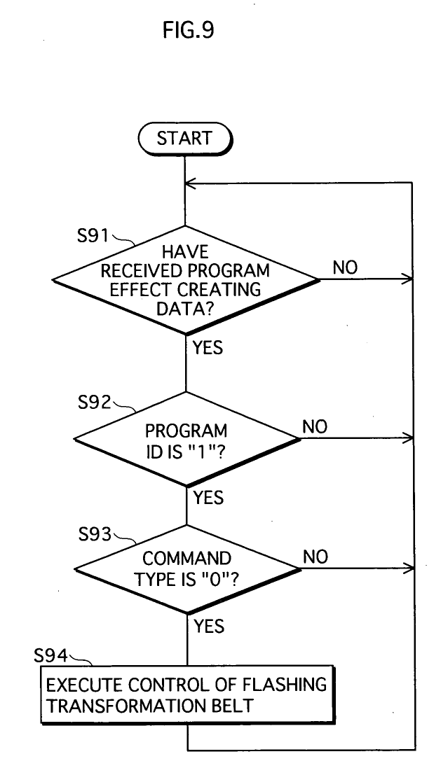

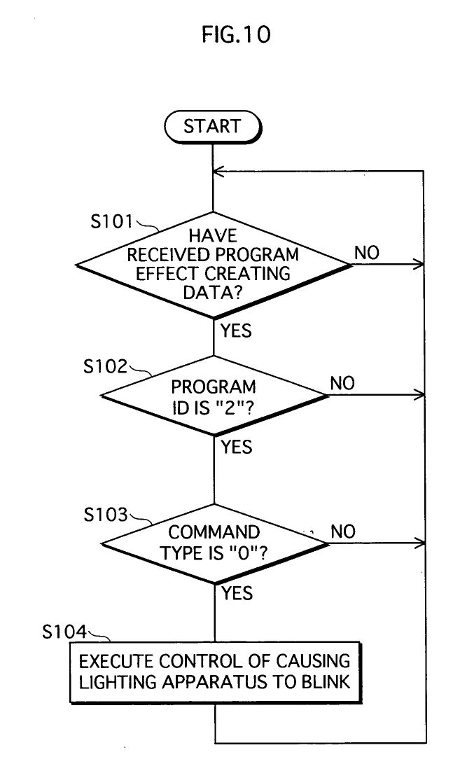

Next, operations of the program effect creating devices are described by assigning specific numerical values. The program effect creating device A 300 and program effect creating device B 301 respectively receive a piece of program effect creating data 42 comprising the program ID 43 of “1”, the cmd 44 of “o”, the len 45 of “1”, and the opr 46 of “1” at the time T2 when the transformation scene in the broadcast program 701 is displayed. Here, the operations of the program effect creating device A 300 and program effect creating device B 301 at this point are explained with the aid of flowcharts shown in FIGS. 9 and 10. Assume that the program effect creating device A 300 stores a program ID of “1” and a command type of “o” therein while the program effect creating device B 301 storing a program ID of “2” and a command type of “0” therein.

The program effect creating device A 300 operates according to the flowchart in FIG. 9, and operates as follows when receiving a piece of program effect creating data 42 comprising the program ID 43 of “1”, the cmd 44 of “0”, the len 45 of “1”, and the opr 46 of “1”. First, the program effect creating device A 300 judges whether to have received a piece of program effect creating data 42 (Step S91). Since here it is YES, the program effect creating device A 300 judges whether the program ID 43 of the piece of program effect creating data 42 is “1” (Step S92). Since here it is YES, the program effect creating device A 300 judges whether the cmd 44 of the piece of program effect creating data 42 is “0” (Step S93). Since here it is YES, the program effect creating device A 300 executes the control of flashing the transformation belt for ten seconds (Step S94), and then returns to wait mode and stays in the mode until receiving a new piece of program effect creating data 42.

Accordingly, it is possible to achieve control of flashing the transformation belt at the time T2 when the transformation scene in the broadcast program 701 is displayed. As a result, the users can enjoy the broadcast program 701 with a very realistic sense of presence in conjunction with the content of the broadcast program 701 by using the program effect creating device A 300, i.e. the transformation belt.

On the other hand, the program effect creating device B 301 operates according to the flowchart in FIG. 10, and operates as follows when receiving a piece of program effect creating data 42 comprising the program ID 43 of “1”, the cmd 44 of “0”, the len 45 of “1”, and the opr 46 of “1”.

First, the program effect creating device B 301 judges whether to have received a piece of program effect creating data 42 (Step S101). Since here it is YES, the program effect creating device B 301 judges whether the program ID 43 of the piece of program effect creating data 42 is “2” (Step S102). Since here it is NO, the program effect creating device B 301 returns to wait mode and stays in the mode until receiving a new piece of program effect creating data 42.

Accordingly, the program effect creating device B 301 does not perform control of causing the lighting apparatus to blink (Step S104) at the time T2 when the transformation scene starts.

Next are described operations of the program effect creating device A 300 and program effect creating device B 301 at the time T5 when the storm scene of the broadcast program 702 is displayed.

The program effect creating device A 300 operates according to the flowchart in FIG. 9, and operates as follows when receiving a piece of program effect creating data 42 comprising the program ID 43 of “2”, the cmd 44 of “0”, the len 45 of “1”, and the opr 46 of “1”. First, the program effect creating device A 300 judges whether to have received a piece of program effect creating data 42 (Step S91). Since here it is YES, the program effect creating device A 300 judges whether the program ID 43 of the program effect creating data 42 is “1” (Step S92). Since here it is NO, the program effect creating device A 300 returns to wait mode and stays in the mode until receiving a new piece of program effect creating data 42.

Accordingly, the program effect creating device A 300 does not perform control of flashing the transformation belt (Step S94) at the time T5 when the storm scene is displayed.

On the other hand, the program effect creating device B 301 operates according to the flowchart in FIG. 10, and operates as follows when receiving a piece of program effect creating data 42 comprising the program ID 43 of “2”, the cmd 44 of “0”, the len 45 of “1”, and the opr 46 of “1”. First, the program effect creating device B 301 judges whether to have received a piece of program effect creating data 42 (Step S101). Since here it is YES, the program effect creating device B 301 judges whether the program ID 43 of the piece of program effect creating data 42 is “2” (Step S102). Since here it is YES, the program effect creating device B 301 judges whether the cmd 44 of the piece of program effect creating data 42 is “0” (Step S103). Since here it is YES, the program effect creating device B 301 execute the control of causing the lighting apparatus to blink (Step S104), and then returns to wait mode and stays in the mode until receiving a new piece of program effect creating data 42.

Accordingly, it is possible to achieve control of causing the lighting apparatus to blink at the time T5 when the storm scene in the broadcast program 702 is displayed. As a result, the users can enjoy the broadcast program 702 with a very realistic sense of presence in conjunction with the content of the broadcast program 702 by using the program effect creating device B 301, i.e. the lighting apparatus.

As has been described, according to the present embodiment, the program effect creating device A 300 and program effect creating device B 301 are capable of executing various pieces of program effect creating data 42 each synchronized with a given scene in a broadcast program. Accordingly, the users can enjoy broadcast programs with a very realistic sense of presence. Furthermore, each of the program effect creating device A 300 and program effect creating device B 301 is able to avoid executing pieces of program effect creating data 42 of a broadcast program not corresponding to itself by checking program IDs 43 included therein. Consequently, it is possible to prevent the program effect creating devices from unreasonably operating with broadcast programs, which in turn prevents operations unintended by the user.

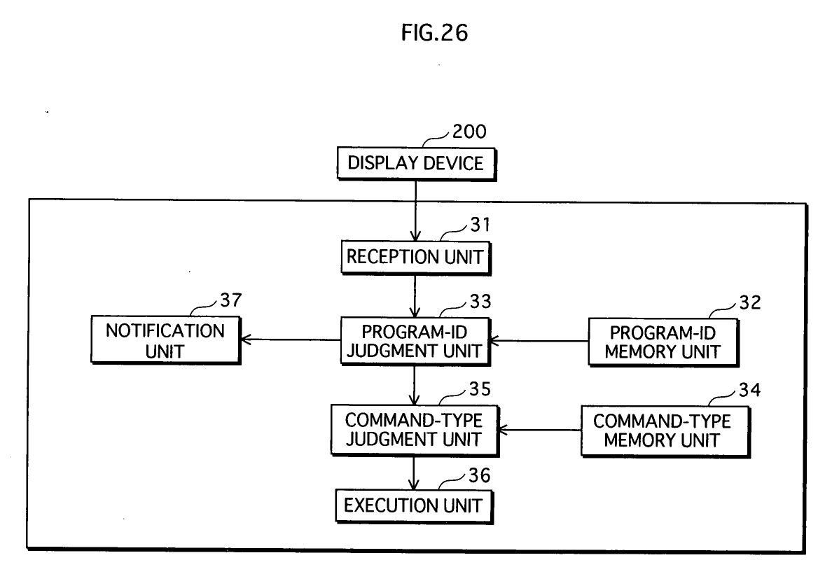

Note that, when receiving a piece of program effect creating data 42 of an irrelevant broadcast program, the program effect creating device A 300 and program effect creating device B 301 do not only keep from performing the program effect creation, but also each device may notify the user that a program effect creating device not corresponding to the received piece of program effect creating data (i.e. the device itself) is on. In this case, a program effect creating device A 300a and a program effect creating device B 301a respectively include a notification unit 37 as shown in FIG. 26.

When the received piece of program effect creating data 42 is judged to be as irrelevant to a corresponding program effect creating device, the notification unit 37 generates a sound to notify the user accordingly.

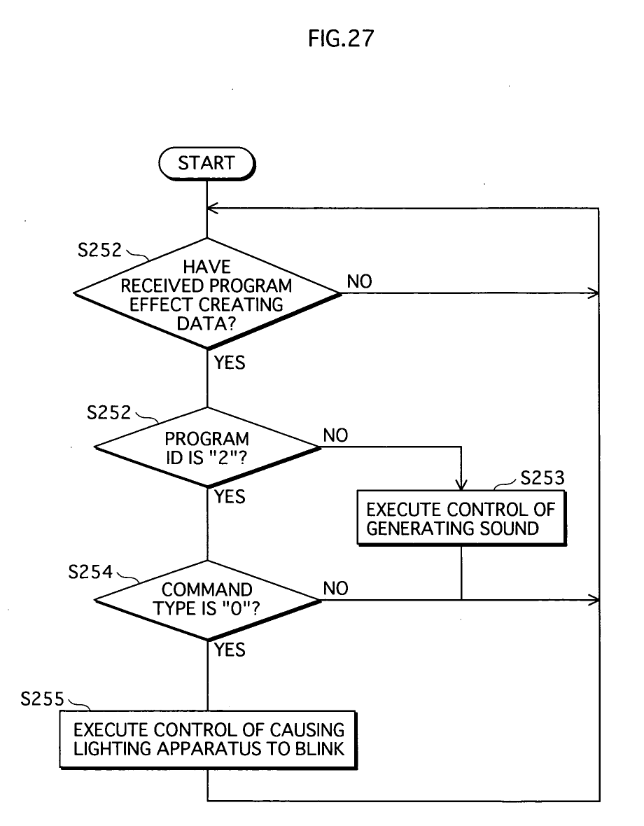

The operations of the notification unit 37 are described below with the aid of a flowchart shown in FIG. 27.

Assume that the above-mentioned broadcast program 701 is being broadcast. The program effect creating device B 301a receives a piece of program effect creating data 42 comprising the program ID 43 of “1”, the cmd 44 of “0”, the len 45 of “1”, and the opr 46 of “1” at the time T2. The program effect creating device B 301a judges whether to have received a piece of program effect creating data 42 (Step S251). Since here it is YES, the program effect creating device B 301a judges whether the program ID 43 of the received piece of program effect creating data 42 is “2” (Step S252). Since here it is NO, the program effect creating device B 301a executes the control to cause the notification unit 37 to generate a sound (Step S253), and then returns to wait mode and stays in the mode until receiving a new piece of program effect creating data 42.

Accordingly, during the broadcast program 701 being broadcast, it is possible to notify the user that the power of the program effect creating device B 301a is on when the time reaches the time T2 at which the transformation scene is displayed.

Note that the notification unit 37 here notifies the user by sound. However, a different method may be used for this purpose, such as presenting a notice on a display or the like, for example.

In addition, assume that computer programs which control the program effect creating device A 300a and the program effect creating device B 301a, respectively, are individually stored in a cartridge type ROM. In such a case, if software not corresponding to a broadcast program is set in these program effect creating devices, the corresponding notification units 37 may respectively notify the user accordingly. The operations of the program effect creating device A 300a at this point are described with the aid of the flowchart shown in FIG. 27. Assume that the above-mentioned broadcast program 701 is being broadcast, and a ROM which stores a control program for the broadcasting program 702 has been mistakenly set in the program effect creating device A 300a. At the time T2, the program effect creating device A 300a receives a piece of program effect creating data 42 comprising the program ID 43 of “1”, the cmd 44 of “0”, the len 45 of “1”, and the opr 46 of “1”. The program effect creating device A 300a judges whether to have received a piece of program effect creating data 42 (Step S251). Since here it is YES, the program effect creating device A 300a judges whether the program ID 43 of the piece of program effect creating data 42 is “2” (Step S252). Since here it is NO, the program effect creating device A 300a executes the control to cause the notification unit 37 to generate a sound (Step S253), and then returns to wait mode and stays in the mode until receiving a new piece of program effect creating data 42.

Accordingly, the user can be aware by the sound generated by the notification unit 37 that a ROM corresponding to a broadcast program currently being broadcast is not set in the program effect creating device A 300a.

### 2. Second Embodiment

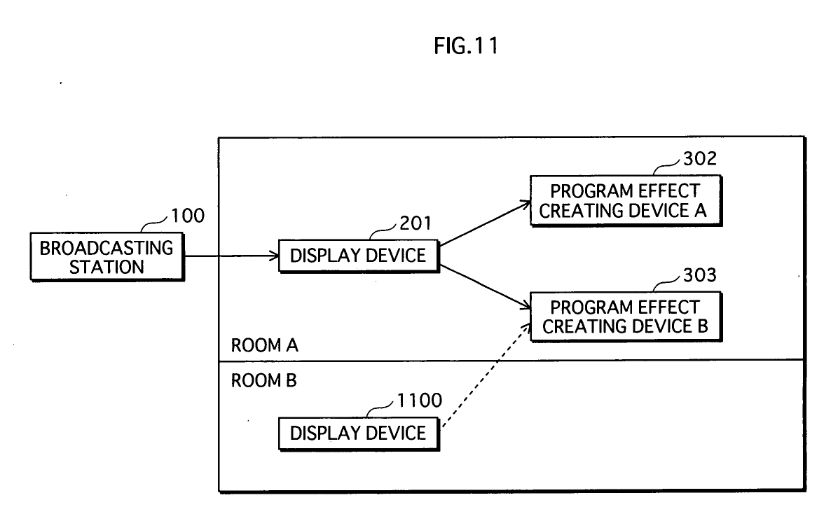

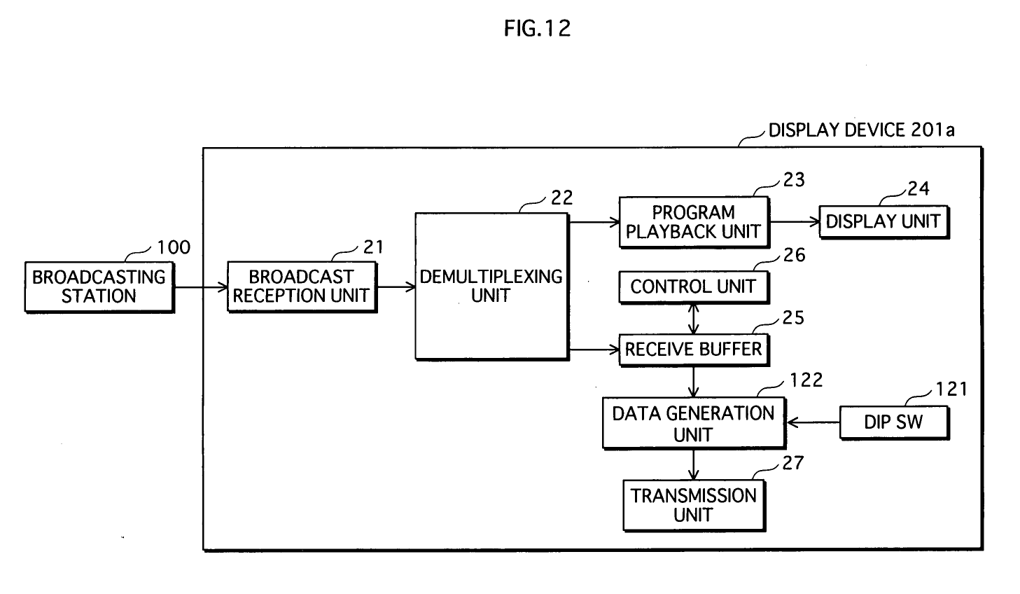

In the first embodiment, erroneous operations of the program effect creating device A 300 and program effect creating device B 301 are prevented by the use of the program IDs 43. However, although being capable of preventing these program effect creating devices from operating in conjunction with an irrelevant broadcast program, the first embodiment does not factor in the case when the program effect creating devices receive pieces of program effect creating data 42 from multiple display devices. For example, as shown in FIG. 11, the program effect creating devices could operate by receiving a piece of program effect creating data 42 from a display device 1100 in an adjoining room. Therefore, the present embodiment prevents this erroneous operation by setting a random DIP SW value to a display device 201 and also setting the same value to the program effect creating devices. As shown in FIG. 12, a display device 201a includes a DIP SW 121 and a data generation unit 122.

The DIP SW 121 is a type of setting switch housing a series of tiny switches and used for electronics devices whose operations can be controlled by turning these tiny switches on and off.

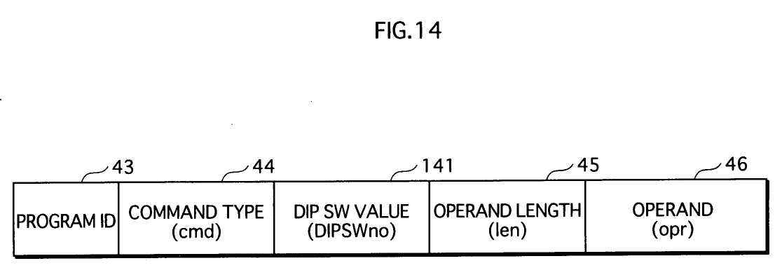

The data generation unit 122 reads a value of the DIP SW 121, and adds the DIP SW value to a piece of program effect creating data 42 to generate a piece of added program effect creating data. FIG. 14 shows the piece of added program effect creating data. As shown in the figure, the piece of added program effect creating data is composed of: the program ID 43; the command type (cmd) 44; a DIP SW value (DIPSWno) 141; the operand length (len) 45; and the operand (opr) 46.

The DIP SW value 141 is a value used for identifying the display device 201a, indicating one of values that the DIP SW 121 can possibly take.

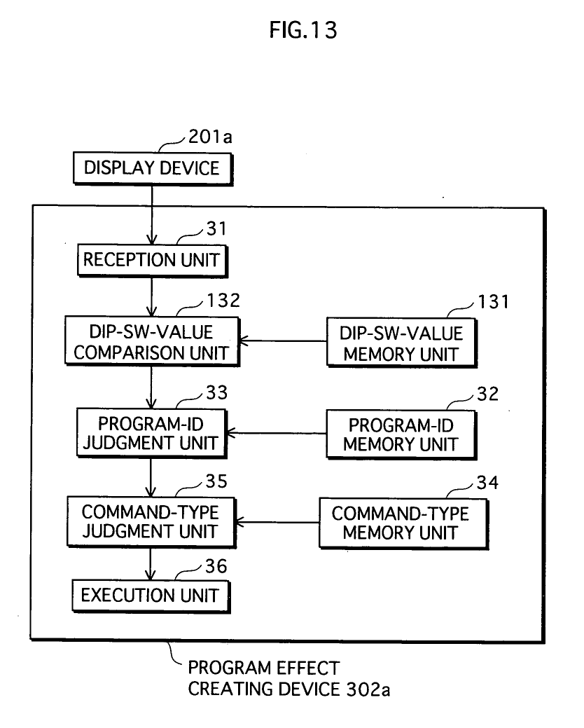

In addition, the same DIP SW value as set in the display device 201a is set in a program effect creating device A 302a and a program effect creating device B 303a. Each of the program effect creating devices checks a piece of added program effect creating data, and performs its program effect creation when the DIP SW value 141 included in the piece of added program effect creating data agrees with a DIP SW value set in itself. As shown in FIG. 13, the program effect creating device A 302a includes a DIP-SW-value memory unit 131 and a DIP-SW-value comparison unit 132.

The DIP-SW-value memory unit 131 stores a currently set DIP SW value of the program effect creating device A 302a therein.

The DIP-SW-value comparison unit 132 compares the DIP SW value stored by the DIP-SW-value memory unit 131 with the DIP SW value 141 in the piece of added program effect creating data received by the receiving unit 31.

Note here that the program effect creating device B 303a has the same structure as the program effect creating device A 302a shown in FIG. 13.

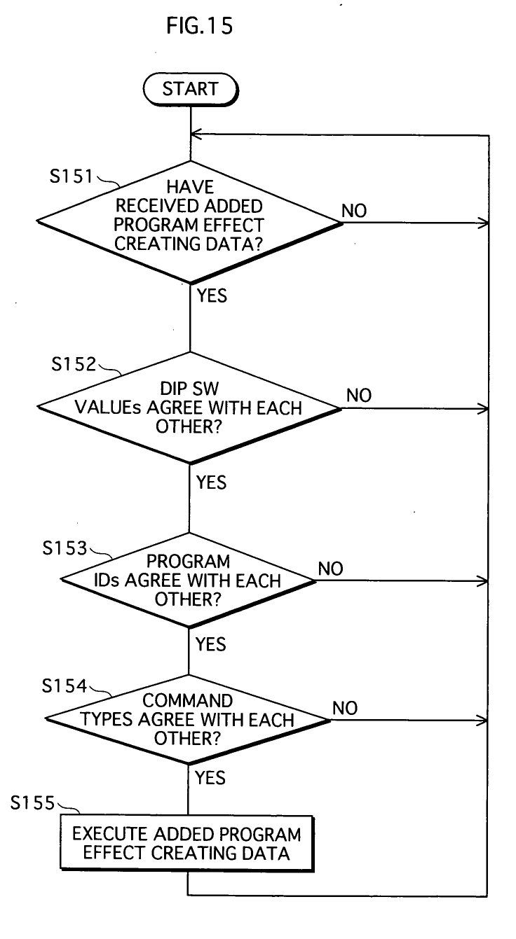

Next, the operations of the program effect creating device A 302a and program effect creating device B 303a are described with the aid of a flowchart shown in FIG. 15. First, the program effect creating device A 302a and program effect creating device B 303a respectively judge whether to have received a piece of added program effect creating data (Step S151). If NO, these program effect creating devices are in wait mode until receiving one. If YES, each program effect creating device judges whether a DIP SW value stored by the DIP-SW-value memory unit 131 and the DIP SW value 141 included in the received piece of added program effect creating data agree with each other (Step S152). If NO, the program effect creating device returns to wait mode and stays in the mode until receiving a new piece of added program effect creating data. If YES, the program effect creating device judges whether a program ID stored by the program-ID memory unit 32 and the program ID 43 included in the received piece of added program effect creating data agree with each other (Step S153). If NO, the program effect creating device returns to wait mode and stays in the mode until receiving a new piece of added program effect creating data. If YES, the program effect creating device judges whether a command type stored by the command-type memory unit 34 and the command type 44 included in the received piece of added program effect creating data agree with each other (Step S154). If NO, the program effect creating device returns to wait mode and stays in the mode until receiving a new piece of added program effect creating data. If YES, the program effect creating device executes the piece of added program effect creating data (Step S155).

As has been described, according to the present embodiment, the program effect creating device A 302a and program effect creating device B 303a identify the display device 201a by the DIP SW value. Accordingly, even if having received a piece of program effect creating data from the display device 1100 in the adjoining room, these program effect creating devices do not operate if their DIP SW values disagree with a DIP SW value included in the received piece of program effect creating data, and thus the above-stated erroneous operation can be prevented.

Note that, although DIP SWs are used in the second embodiment in order to prevent erroneous operations, the present invention is not limited to this. A different device can be used instead, as long as it serves the same function as the DIP SWs. That is, it is acceptable if the substitute device is capable of setting a numerical value at random by employing an input method of some sort. For example, the numerical value may be set at random by a remote control or the like.

### 3. Third Embodiment

In the second embodiment, a random DIP SW value is set to the display device 201a, and the same DIP SW value is set to the program effect creating device A 302a as well as to the program effect creating device B 303a. Each program effect creating device judges whether its own DIP SW value agrees with the DIP SW value set in the display device 201a to thereby prevent erroneous operations. However, when there are multiple display devices, DIP SW values of these display devices are not unique to each display device. That is, multiple display devices may share the same DIP SW value. In this case, the program effect creating device A 302a and program effect creating device B 303a may possibly cause erroneous operations. Accordingly, the present embodiment prevents such erroneous operations by using a serial number assigned to each display device and thereby identifying a corresponding display device.

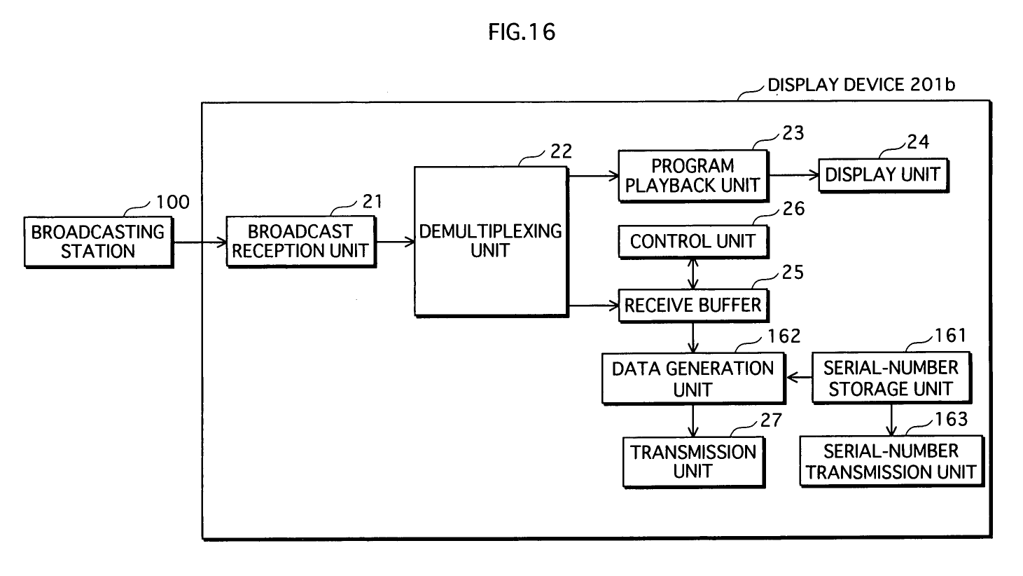

In the present embodiment, a display device 201b includes: a serial-number storage unit 161; a data generation unit 162; and a serial-number transmission unit 163, as shown in FIG. 16.

The serial-number storage unit 161 stores a serial number of the display device 201b therein.

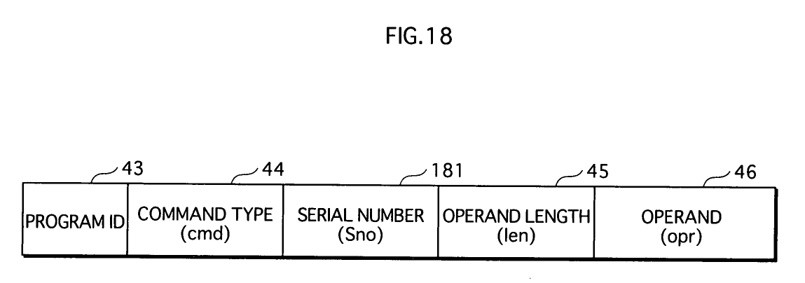

The data generation unit 162 reads the serial number from the serial-number storage unit 161, and adds the serial number to a piece of program effect creating data 42 to generate a piece of added program effect creating data. FIG. 18 shows the piece of added program effect creating data. As shown in the figure, the piece of added program effect creating data is composed of: the program ID 43; the command type (cmd) 44; a serial number (Sno) 181; the operand length (len) 45, and the operand (opr) 46. The serial number 181 is a unique number assigned to each display device.

The serial-number transmission unit 163 transmits the serial number to program effect creating devices.

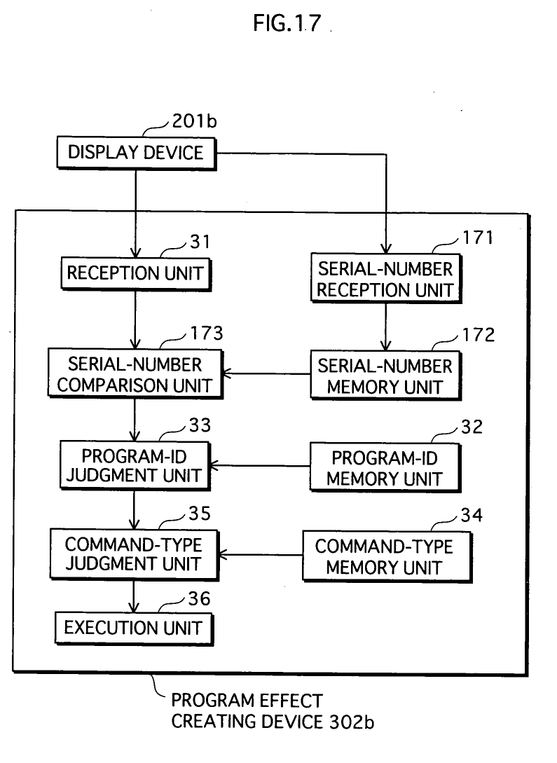

As shown in FIG. 17, a program effect creating device A 302b includes a serial-number reception unit 171, a serial-number memory unit 172, and a serial-number comparison unit 173. Note here that a program effect creating device B 303b also has the same structure as the program effect creating device A 302b.

Note that a serial number of a corresponding display device shall be registered to the program effect creating device A 302b as well as to the program effect creating device B 303b in advance. The registration is implemented by manual setting or through communication by connecting each program effect creating device with the display device.

The serial-number reception unit 171 receives a serial number transmitted from a display device.

The serial-number memory unit 172 stores the received serial number therein.

The serial-number comparison unit 173 compares a serial number included in the received piece of added program effect creating data against the serial number stored by the serial-number memory unit 172.

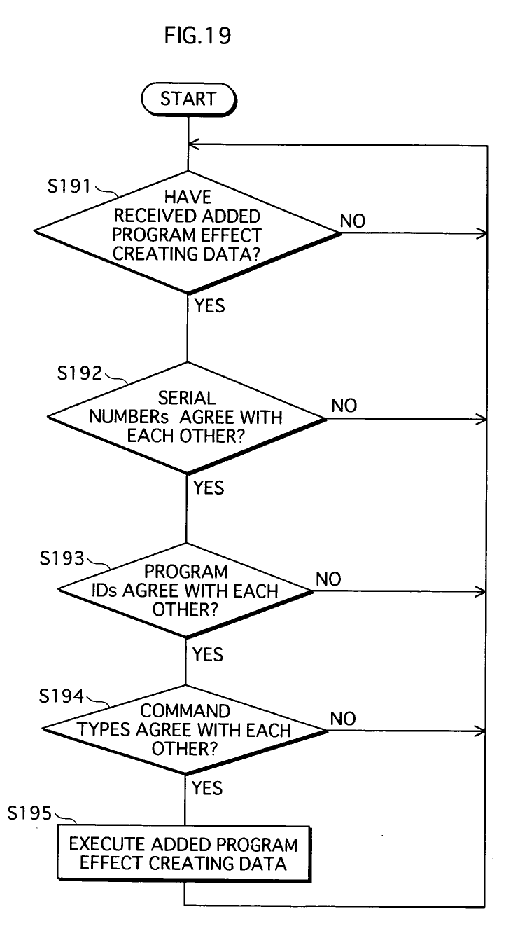

Next, operations of the program effect creating device A 302b and program effect creating device B 303b are described with the aid of a flowchart shown in FIG. 19. First, the program effect creating device A 302b and program effect creating device B 303b respectively judge whether to have received a piece of added program effect creating data (Step S191). If NO, these program effect creating devices are in wait mode until receiving one. If YES, each program effect creating device judges whether a serial number included in the received piece of added program effect creating data and a serial number stored by the serial-number memory unit 172 of the program effect creating device agree with each other (Step S192). If NO, the program effect creating device returns to wait mode and stays in the mode until receiving a new piece of added program effect creating data. If YES, the program effect creating device judges whether a program ID stored by the program-ID memory unit 32 and the program ID 43 included in the received piece of added program effect creating data agree with each other (Step S193). If NO, the program effect creating device returns to wait mode and stays in the mode until receiving a new piece of added program effect creating data. If YES, the program effect creating device judges whether a command type stored by the command-type memory unit 34 and the command type 44 included in the received added program effect creating data agree with each other (Step S194). If NO, the program effect creating device returns to wait mode and stays in the mode until receiving a new piece of added program effect creating data. If YES, the program effect creating device executes the received piece of added program effect creating data (Step S195).

As has been described, according to the present embodiment, the program effect creating device A 302b and program effect creating device B 303b identify display devices, using serial numbers uniquely assigned to each display device. Accordingly, the respective program effect creating device A 302b and program effect creating device B 303b do not operate with data transmitted from a display device having a serial number other than one stored by each program effect creating device, which results in preventing the above-stated erroneous operations.

### 4. Fourth Embodiment

The present embodiment prevents, in the case there are multiple command types, program effect creating devices from operating against the user's intention by performing filtering in the display device 202 and thereby only transmitting pieces of program effect creating data desired by the user to the program effect creating devices.

When there are multiple command types, the user registers, to the display device 202 in advance, only command types desired to operate. The registration is implemented, for example, by displaying a list of commands on a monitor of the display device 202 and having the user select desired command types from the command list on the screen. Here, the user shall have received a command list corresponding to a broadcast program from the broadcasting station 100 in advance. Alternatively, the user may have obtained the command list through download or the like.

For example, assume the case in which the broadcast program is a baseball game. The user would like to have effects created by the program effect creating devices when a supporting team is performing well. However, the user does not want such effects when the opposing team is performing well. More specifically speaking, when the supporting team hits a home run, effects created by the program effect creating devices, such as light and sound effects, possibly contribute to further lift up the user's spirit. However, if the program effect creating devices perform such effect creation when the opposing team hits a home run, the user would be very displeased. Accordingly, it is necessary to perform filtering command types of the display device 202 and limit data to be transmitted to the program effect creating devices in order to prevent operations unintended by the user. Note that the user shall obtain a command list complied with a live broadcast of the baseball game in advance, and select desired command types before the live broadcast starts.

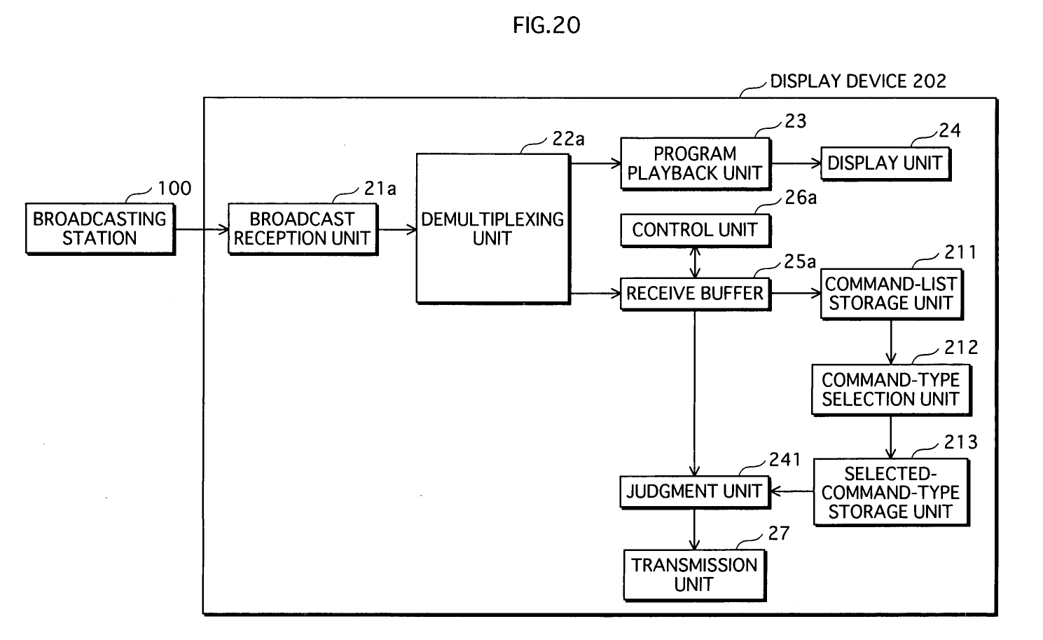

Therefore, the display device 202 includes a command-list storage unit 211, a command-type selection unit 212, a selected-command-type storage unit 213, and a judgment unit 214, as shown in FIG. 20.

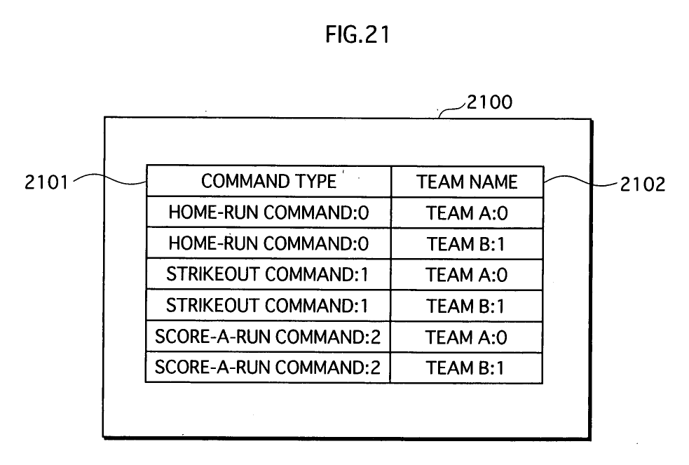

The command-list storage unit 211 stores a command list 2100 therein. As shown in FIG. 21, the command list 2100 is composed of command types 2101 and team identifiers 2102 which used for identifying each team. Thereby, the command types 2101 can be associated with the team identifiers 2102. That is, each of the command types 2101 corresponds to only one of the team identifiers 2102. Therefore, when the user selects a given command type, a team for the command type is counted at the same time.

The command-type selection unit 212 selects desired command types 2101 from the command list 2100 according to the user's direction.

The selected-command-type storage unit 213 stores the command types 2101 selected by the command-type selection unit 212 therein.

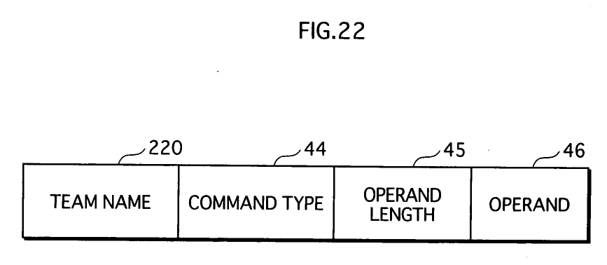

When receiving a piece of program effect creating data sent from a receive buffer 25a, the judgment unit 214 judges whether a command type included in the piece of program effect creating data agrees with one of the command types 2101 stored in the selected-command-type storage unit 213. If YES, the judgment unit 214 sends the piece of program effect creating data to the transmission unit 27. A piece of program effect creating data used in the fourth embodiment is shown in FIG. 22, including a team identifier 220, the command type 44, the operand length 45, and the operand 46.

The team identifier 220 indicates either one of two teams having the baseball game.

As soon as detecting that a piece of program command data is stored in the receive buffer 25a, a control unit 26a instructs the receive buffer 25a to transmit a piece of program effect creating data included in the piece of program command data to the judgment unit 214 right away.

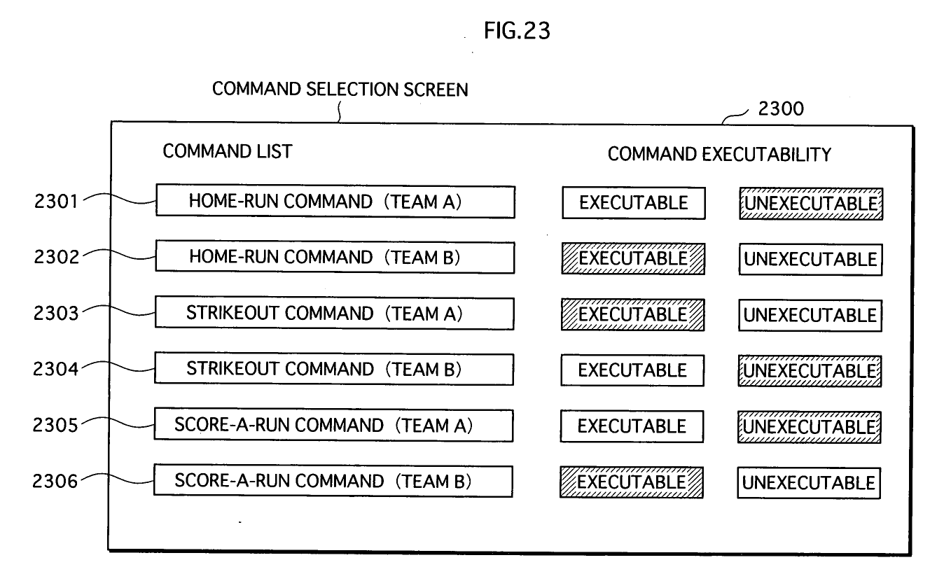

FIG. 23 shows a command selection screen 2300. The user sets command types desired to operate in the command selection screen 2300 in advance. For instance, assume the case in which Home-Run Command (Team B) 2302, Strikeout Command (Team A) 2303, Score-a-Run Command (Team B) 2306 are set as executable while Home-Run Command (Team A) 2301, Strikeout Command (Team B) 2304, and Score-a-Run Command (Team A) 2305 are set as unexecutable. The judgment unit 214 sends to the transmission unit 27 pieces of program effect creating data only including executable command types. That is, the program effect creating devices only receive Home-Run Command (Team B) 2302, Strikeout Command (Team A) 2303, Score-a-Run Command (Team B) 2306. Accordingly, the user is provided with effects created by the program effect creating devices only when the user's supporting team hits a home run and scores a run and when the opposing team gets struck out.

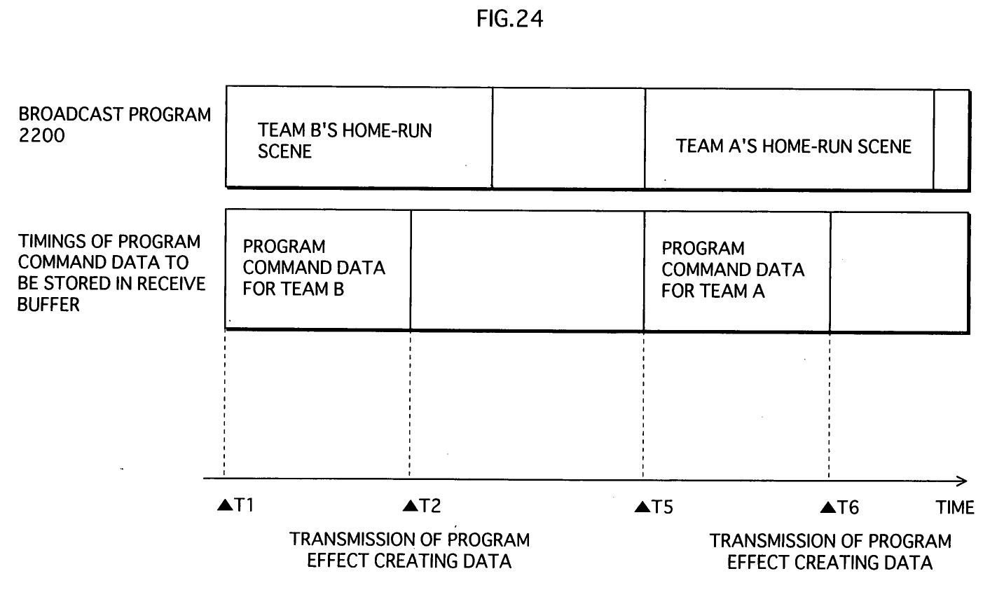

Next, a timing when a piece of program command data is stored in the receive buffer 25a is described with the aid of FIG. 24. When a certain event takes place during the broadcasting program, the broadcasting station 100 transmits to the display device 202 a piece of program command data including the command type 44 corresponding to the event. Here, the event is, for example, a strikeout, a home run, or the like. For instance, when Team B hits a home run, the broadcasting station 100 transmits to the display device 202 a piece of program command data including Home-Run Command (Team B) 2302. Consequently, the piece of program command data is stored in the receive buffer 25a of the display 202 after a time T1, which is the beginning of a scene of the home run.

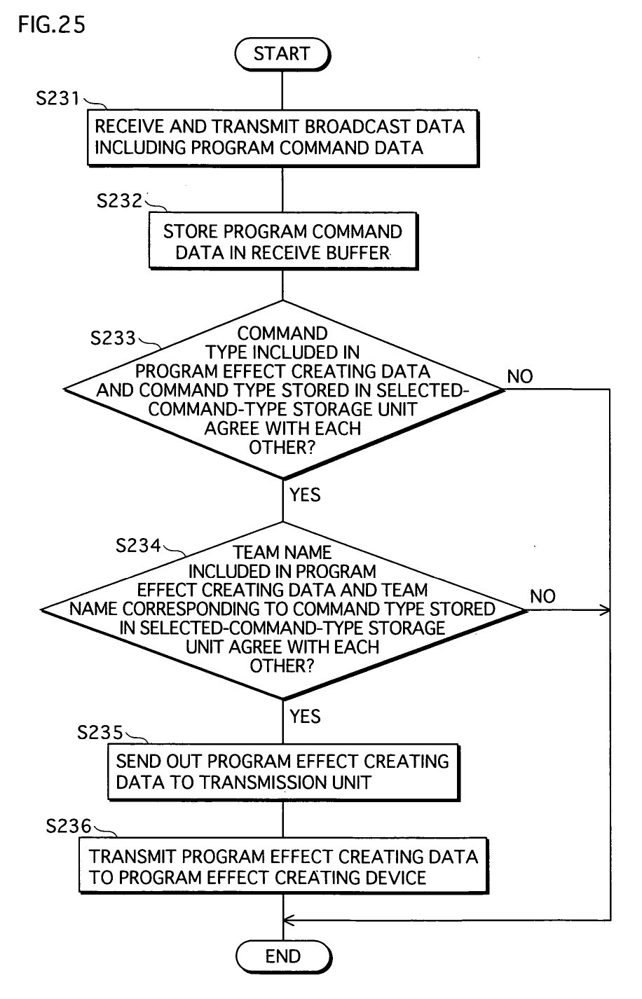

Next, the filtering process performed by the display device 202 is described with the aid of a flowchart shown in FIG. 25. First, a broadcast reception unit 21a receives and transmits broadcast data including a piece of program command data (Step S231) to a demultiplexing unit 22a, which then transmits the piece of program command data to a receive buffer 25a. The receive buffer 25a stores the received piece of program command data therein (Step S232), and subsequently, sends out to the judgment unit 214 a piece of program effect creating data included in the piece of program command data. The judgment unit 214 judges whether the command type 44 included in the piece of program effect creating data agrees with one of the command types stored in the selected-command-type storage unit 213 (Step S233). If NO, the filtering process is terminated. If YES, the judgment unit 214 judges whether the team identifier 220 included in the piece of program effect creating data and a team identifier stored in the selected-command-type storage unit 213 agree with each other (Step S234). If NO, the filtering process is terminated. If YES, the judgment unit 214 sends out the piece of program effect creating data to the transmission unit 27 (Step S235). The transmission unit 27 transmits the piece of program effect creating data to the program effect creating devices (Step S236), and then the filtering process is terminated.

The following provides a specific example to illustrate the operations of the display device 202.

For example, Team B hits a home run during the broadcasting program, the broadcasting station 100 transmits to the display device 202 a piece of program command data including Home-Run Command (Team B) 2302. After the reception unit 21a receives the piece of program command data, the receive buffer 25a stores it therein. Then, the judgment unit 214 judges whether the command type 44 in a piece of program effect creating data included in the piece of program command data agrees with one of the command types stored in the selected-command-type storage unit 213. Since Home-Run Command (Team B) 2302 has been set as executable as shown in FIG. 23, the command type 44 agrees with the command type of Home-Run Command (Team B) 2302 which has been stored in the selected-command-type storage unit 213. Accordingly, the judgment unit 214 sends the piece of program effect creating data out to the transmission unit 27, and the transmission unit 27 transmits the piece of program effect creating data to the program effect creating devices.

As has been described, according to the present embodiment, the user can enjoy a realistic sense of being at the baseball stadium at home. In addition, since only command types previously specified by the user are implemented, operations unintended by the user can be prevented. For example, assume the case in which the broadcasting program is a baseball game and the opposing team hits a home run. If a command type corresponding to an event of the opposing team hitting a home run has been set in the display device 202 as unexecutable in advance, a piece of program effect creating data including the command type 44 will not be transmitted to program effect creating devices, and therefore no effect creation is performed. Thus, it is possible to prevent the program effect creating devices from performing effect creation unintended by the user.

Note that, although the filtering process is performed by the display device 202 in the present embodiment, the program effect creating devices may handle the process instead.

5. Other Modifications

The program effect creating devices according to the present invention have been described based on the preferred embodiments above. However, it goes without saying that the present invention is not confined to the above embodiments.

Although a digital television is used for the display device in the above embodiments, a receiving device can be used instead, as long as it has a function of a display device. Specifically speaking, a PDA (Personal Data Assistant) or a personal computer may be used.

In each of the above embodiments, two program effect creating devices are used, however, more than two program effect creating devices may be used instead, or only one program effect creating device may be used.

Although program IDs are used for judging whether to execute pieces of program effect creating data in the above embodiments, the present invention is not limited to this. For example, time information or type codes of the program effect creating devices may be used for the judging process. Namely, a program-effect-creating-device type code is stored in the program ID 44 included in a piece of program effect creating data, and then transmitted from the broadcasting station 100. By using a computer program in a program effect creating device, it can be judged whether the program-effect-creating-device type code included in the transmitted program effect creating data agrees with a program-effect-creating-device type code possessed by the program effect creating device. Thus, a function equivalent to the program IDs can be achieved.

In the above embodiments, the program effect creating system is realized by using broadcast data sent from the broadcasting station 100. However, an equivalent function may be achieved by using broadcast data stored in a storage medium connected to the display device.

The program effect creating devices are used in the above embodiments, however, the present invention may be a program or a computer-readable recording medium which includes program codes causing a computer to execute the steps shown in the above flowcharts.

The display devices are used, in the above embodiments, as a form of the receiving device according to the present invention, however, the receiving device of the present invention may be realized by a program or a computer-readable recording medium which includes program codes causing a computer to execute the steps shown in the above flowcharts, instead.

The receiving devices are used in the above embodiments, however, the present invention may be a program or a computer-readable recording medium which include program codes causing a computer to execute the steps shown in the above flowcharts.

Each of the program effect creating devices in the above embodiments stores only one program ID therein, however, the program effect creating devices may individually store multiple program IDs therein so as to be compatible with multiple broadcast programs.

Each of the program effect creating devices in the above embodiments stores a serial number of only one display device therein, however, the program effect creating devices may individually store more than one serial number therein so as to accommodate multiple display devices.

Although the present invention has been fully described by way of example with reference to accompanying drawings, it is to be noted that various changes and modifications will be apparent to those skilled in the art. Therefore, unless otherwise such changes and modifications depart from scope of the present invention, they should be constructed as being included therein.

1. A program effect creating device for performing effect creation for a broadcast program by receiving a command and executing the received command in synchronization with a predetermined scene in the broadcast program, comprising:
a memory unit operable to store a predefined identifier;
a judgment unit operable to judge whether an identifier appended to the received command agrees with the predefined identifier stored by said memory unit; and
an execution unit operable to, when a judgment result of said judgment unit is affirmative, decode and execute the received command to thereby perform the effect creation.

2. The program effect creating device of claim 1, wherein
the effect creation includes at least one of a sound effect, a light emitting effect, and a vibrating effect.

3. The program effect creating device of claim 1, wherein
the predefined identifier is a program identifier identifying the broadcast program with which the program effect creating device is to synchronize,
the appended identifier includes a program identifier identifying a broadcast program currently being broadcast, and
said judgment unit judges whether the program identifiers agree with each other.

4. The program effect creating device of claim 1, wherein
the predefined identifier is a device identifier indicating the program effect creating device,
the appended identifier includes a device identifier specifying a program effect creating device by which the received command is to be executed, and
said judgment unit judges whether the device identifiers agree with each other.

5. The program effect creating device of claim 1, further comprising:
a DIP switch value memory unit operable to store a setting value of a DIP switch provided in the program effect creating device, wherein
the appended identifier includes a setting value of a DIP switch provided in a receiving device by which the command was transmitted to the program effect creating device, and
said judgment unit further judges whether the setting values agree with each other.

6. The program effect creating device of claim 1, further comprising:
a serial number memory unit operable to store a serial number specifying a receiving device corresponding to the program effect creating device, wherein
the appended identifier includes a serial number specifying a receiving device by which the command was transmitted to the program effect creating device, and
said judgment unit further judges whether the serial numbers agree with each other.

7. The program effect creating device of claim 1, further comprising:
a notification unit operable to, when a judgment result of said judgment unit is negative, notify a user that the appended identifier does not agree with the predefined identifier.

8. A receiving device for receiving a program stream to which one or more commands are appended, comprising:
a receiving unit operable to receive a condition list specifying execution conditions of a plurality of commands prior to the reception of the program stream;
a selection unit operable to display the received condition list and select at least one of the execution conditions from the displayed condition list according to a user operation;
an extraction unit operable to extract the appended commands upon the reception of the program stream;
a judgment unit operable to judge whether a predefined identifier included in each of the extracted commands agrees with one of the selected execution conditions; and
a transmission unit operable to transmit individual extracted commands each including the predefined identifier determined by said judgment unit as to agree with one of the selected execution conditions.

9. A computer-readable program used in a computer so as to perform processing of effect creation for a broadcast program, the processing including receiving a command and executing the received command in synchronization with a predetermined scene in the broadcast program, comprising:
judgment code operable to cause the computer to judge whether an identifier appended to the received command agrees with a predefined identifier stored by the computer; and
execution code operable to, when the identifiers are determined to agree with each other, cause the computer to decode and execute the received command to thereby perform the effect creation.

10. A recording medium storing a computer-readable program used in a computer to perform processing of effect creation for a broadcast program, the processing including receiving a command and executing the received command in synchronization with a predetermined scene in the broadcast program,
the program comprising:
judgment code operable to cause the computer to judge whether an identifier appended to the received command agrees with a predefined identifier stored by the computer; and
execution code operable to, when the identifiers are determined to agree with each other, cause the computer to decode and execute the received command to thereby perform the effect creation.

11. A computer-readable program used in a computer so as to perform a process of receiving a program stream to which one or more commands are appended, comprising:
receiving code operable to cause the computer to receive a condition list specifying execution conditions of a plurality of commands prior to the reception of the program stream;
selection code operable to cause the computer to display the received condition list and to select at least one of the execution conditions from the displayed condition list according to a user operation;
extraction code operable to cause the computer to extract the appended commands upon the reception of the program stream;
judgment code operable to cause the computer to judge whether a predefined identifier included in each of the extracted commands agrees with one of the selected execution conditions; and
transmission code operable to cause the computer to transmit individual extracted commands each including the predefined identifier determined as to agree with one of the selected execution conditions.

12. A recording medium storing a computer-readable program used in a computer to perform a process of receiving a program stream to which one or more commands are appended,
the program comprising:
receiving code operable to cause the computer to receive a condition list specifying execution conditions of a plurality of commands prior to the reception of the program stream;
selection code operable to cause the computer to display the received condition list and to select at least one of the execution conditions from the displayed condition list according to a user operation;
extraction code operable to cause the computer to extract the appended commands upon the reception of the program stream;
judgment code operable to cause the computer to judge whether a predefined identifier included in each of the extracted commands agrees with one of the selected execution conditions; and
transmission code operable to cause the computer to transmit individual extracted commands each including the predefined identifier determined as to agree with one of the selected execution conditions.
